(19) United States
(12) Patent Application Publication
(10) Pub. No.: US 2005/0118312 A1
(43) Pub. Date: Jun. 2, 2005

(54) Physiologically synergistic mixtures of fruit components, methods of preparation thereof and methods of use thereof

(76) Inventor: Ephraim Philip Lansky, Haifa (IL)

Correspondence Address: DR. MARK FRIEDMAN LTD.;c/o Bill Polkinghorn, 9003 Florin Way, Upper Marlboro, MD, 20772, US

(21) Appl. No.: 11/028,656

(22) Filed: Jan. 5, 2005

Related U.S. Application Data
(63) Continuation-in-part of application No. 10/217,430, filed on Aug. 14, 2002, now abandoned.
Application No. 10/217,430 is a continuation-in-part of application No. 09/859,431, filed on May 18, 2001, now abandoned.
Application No. 09/859,431 is a continuation-in-part of application No. PCT/IL00/00800, filed on Nov. 29, 2000.
(60) Provisional application No. 60/167,694, filed on Nov. 29, 1999.

(51) Int. Cl. C12C 1/00

(52) U.S. Cl. 426/330.3

(57) ABSTRACT

Edible products useful in improving health and preparation of same are disclosed. The products include a fruit seed component impregnated with at least one dried fruit component, preferably a fermented fruit component. Preparation is by combining a fruit seed component with a liquid fruit fermentation component to produce a slurry which is dried to produce the edible product which is the fruit seed component impregnated with a dried fruit component, preferably a fermented fruit component. Administering a physiologically effective amount of the edible product to a subject constitutes a method of improving health of the subject.

This application is a CIP of U.S. application Ser. No. 10/217,430 file 14 Aug. 2002 and currently pending, which is a CIP of U.S. application Ser. No. 09/859,431 filed May 18, 2001 and currently abandoned which was a CIP of PCT application IL00/00800 filed 06 Oct. 2000, which claimed priority from U.S. application 60/167,694 filed 29 Nov. 1999 and currently abandoned.

### FIELD AND BACKGROUND OF THE INVENTION

The present invention relates to physiologically synergistic mixtures of fruit components useful in improving health, methods of preparation thereof and methods of use thereof. Specifically, the present invention relates to a fruit seed product impregnated with a dried fruit product, preferably a fermented fruit product. The invention further includes methods for improving health of a subject via oral administration of the product. Methods for preparation of a fruit seed product impregnated with a dried fruit product, preferably a fermented fruit product, are also disclosed.

Pomegranate (Punica granatum) has long been recognized as a fruit with many benefits for health.¹ The plant is botanically unique, having actually only one true botanical relative, the pomegranate precursor, Punica protopunica, restricted to the isolated island Socotra off the coast of Yemen. Corresponding to this botanical uniqueness is a parallel distinctiveness in terms of biochemistry. For example, pomegranate has long been recognized as the richest plant source of the female steroid hormone estrone,² and recently, the male hormone testosterone and another female steroid, estriol, have also been discovered in pomegranate seed oil.³ A wide range of polyphenolic compounds including flavonoids, anthocyanins and tannins have been characterized both in pomegranate juice⁴ and pericarp.⁵ Further, concentrations of these polyphenols extracted both from the fermented juice and the oil have been shown to be potently antioxidant in vitro and to additionally inhibit the eicosanoid enzyme lipoxygenase, and in the case of the polyphenols extracted from pomegranate seed oil, to also be significantly inhibitory of another eicosanoid pathway enzyme, cyclooxygenase.⁶ However, previous research into medical applications of pomegranate products has focused on isolation and purification of single compounds or extracts. Thus, the potential physiologic synergy between various portions of the pomegranate fruit has been ignored.
¹Frawley, D and Lad, V. The Yoga of Herbs: An Ayurvedic Guide to Herbal Medicine, Lotus Press, Twin Lakes, Wis. 1986.

²Moneam, N. M. A., El Sharaky, A. S., and Badreldin, M. M. Oestrogen content of pomegranate seeds. Journal of Chromotography 438: 438-442, 1988.

³Abd El Wahab, S. M., El Fiki, S. F., Mostafa, S. F. and Hassan, A. E. B. Characterization of certain steroid hormones in Punica granatum L. seeds. Bulletin of the Faculty of Pharmacy of Cairo University 36(1): 11-15, 1998.

⁴Artik, N., Cemeroglu, B., Burakami, H., and Mori, T. Determination of phenolic compounds in pomegranate juice by HPLC. Fruit Process 8 (12): 492-499, 1998.

⁵Ben Nasr, C., Ayed, N., and Metche, M. Quantitative determination of the polyphenolic content of pomegranate peel. Z Lebensm Unters Forsch 203 (4): 374-378, 1996.

⁶Schubert, S. Y., Lansky, E. P., and Neeman, I. Antioxidant and eicosanoid enzyme inhibition properties of pomegranate seed oil and fermented juice flavonoids. Journal of Ethnopharmacology 66 (1): 11-17, 1999.

Further, previous attempts to spray dry fruit juice components did not yield a free flowing powder suitable for encapsulation.

There is thus a widely recognized need for, and it would be highly advantageous to have, physiologically synergistic mixtures of fruit components useful in improving health, methods of preparation thereof and methods of use thereof.

### SUMMARY OF THE INVENTION

According to one aspect of the present invention there is provided an edible product. The product includes a fruit seed component; and a dried fruit component. The fruit seed component is impregnated with the dried fruit component.

According to another aspect of the present invention there is provided a method of producing an edible product. The method includes: (a) providing a fruit seed component; (b) combining the fruit seed component with a liquid fruit component to produce a slurry; and (c) drying the slurry to produce the edible product which includes the fruit seed component impregnated with the dried fruit component.

According to yet another aspect of the present invention there is provided a method of improving the health of a subject. The method includes administering a physiologically effective amount of a pomegranate seed component impregnated with a dried pomegranate fermentation component. Preferably the pomegranate seed component is oil extruded.

According to further features in preferred embodiments of the invention described below, the fruit seed component includes at least one item selected from the group consisting of a seed cake, seeds, milled seeds and seed powder.

According to still further features in the described preferred embodiments the fruit component includes at least one item selected from the group consisting of a juice, a fermented juice, an extract of peel and a fermentation mixture including primarily fruit peel, water, sugar and yeast.

According to still further features in the described preferred embodiments the product includes 5 to 10% w/w, more preferably 7 to 8% w/w, most preferably 7.5% w/w of the dried fruit component.

According to still further features in the described preferred embodiments includes 10 to 30% w/w more preferably 14 to 16% w/w, most preferably 15% w/w of the dried fruit component.

According to still further features in the described preferred embodiments the fruit is a pomegranate.

According to still further features in the described preferred embodiments the fruit seed is oil extracted.

According to still further features in the described preferred embodiments the edible product is provided as an article of manufacture further including packaging material and instructions for use.

According to still further features in the described preferred embodiments the instructions identify the product as useful in ameliorating symptoms associated with menopause (e.g. climacteria).

According to still further features in the described preferred embodiments the instructions identify the product as useful in promoting cardiac health (e.g. discourages formation of atherosclerotic plaques).

According to still further features in the described preferred embodiments the product is supplied in an orally administrable form selected from the group consisting of consisting of a tablet and a capsule.

According to still further features in the described preferred embodiments the method is employed to ameliorate symptoms associated with menopause.

According to still further features in the described preferred embodiments the method is employed to promote cardiac health.

The present invention successfully addresses the shortcomings of the presently known configurations by providing physiologically synergistic mixtures of fruit components useful in improving health, methods of preparation thereof and methods of use thereof. Further, the present invention directly contradicts prior art configurations by re-combining fruit components after their separation or purification in order to increase their physiologic potency in a synergistic fashion.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a flow diagram showing production steps in manufacture of an edible product according to the present invention.

### DESCRIPTION OF THE PREFERRED EMBODIMENTS

The present invention is edible products based upon a combination of fruit components and useful in improving health, methods of preparation thereof and methods of use thereof. Further, the present invention directly contradicts prior art configurations by re-combining seed components with peel components and./or juice components after their separation or purification. The invention is expected to find utility in nutraceutical or prophylactic treatment of a variety of medical conditions including, but not limited to, menopausal symptoms (e.g. hot flashes) and the maintenance of good cardiovascular function. The product retards accumulation of atherosclerotic plaques although it may have additional modes of action.

The principles and use of edible products according to the present invention may be better understood with reference to the drawings and accompanying descriptions.

For purposes of this specification and the accompanying claims, the term “fruit” includes, but is not limited to pomegranates, stone fruits, pome fruits, citrus fruits, grapes, berries, melons (e.g. watermelon or cantaloupe), and cucurbits (e.g. zucchini or cucumber). For purposes of this specification and the accompanying claims, the terms “pericarp”, “rind” and “peel” are considered synonymous and are used interchangeably.

For purposes of this specification and the accompanying claims, the terms “pericarp extract”, includes an aqueous extract of pomegranate peel.

For purposes of this specification and the accompanying claims, the phrase “seed cake” refers to seeds from which seed oil has been removed by an accepted industrial process. The seeds are preferably, but not necessarily, crushed or ground to increase the yield of seed oil.

For purposes of this specification and the accompanying claims, the phrase “seed oil” includes the result of a process such as, for example, expeller pressing, supercritical fluid extraction with carbon dioxide, solvent extraction and/or lyophilization.

For purposes of this specification and the accompanying claims, the term “juice” refers to unprocessed juice, fermented juice, partially fermented juice, partially dried juice, reduced juice and partially reduced juice.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

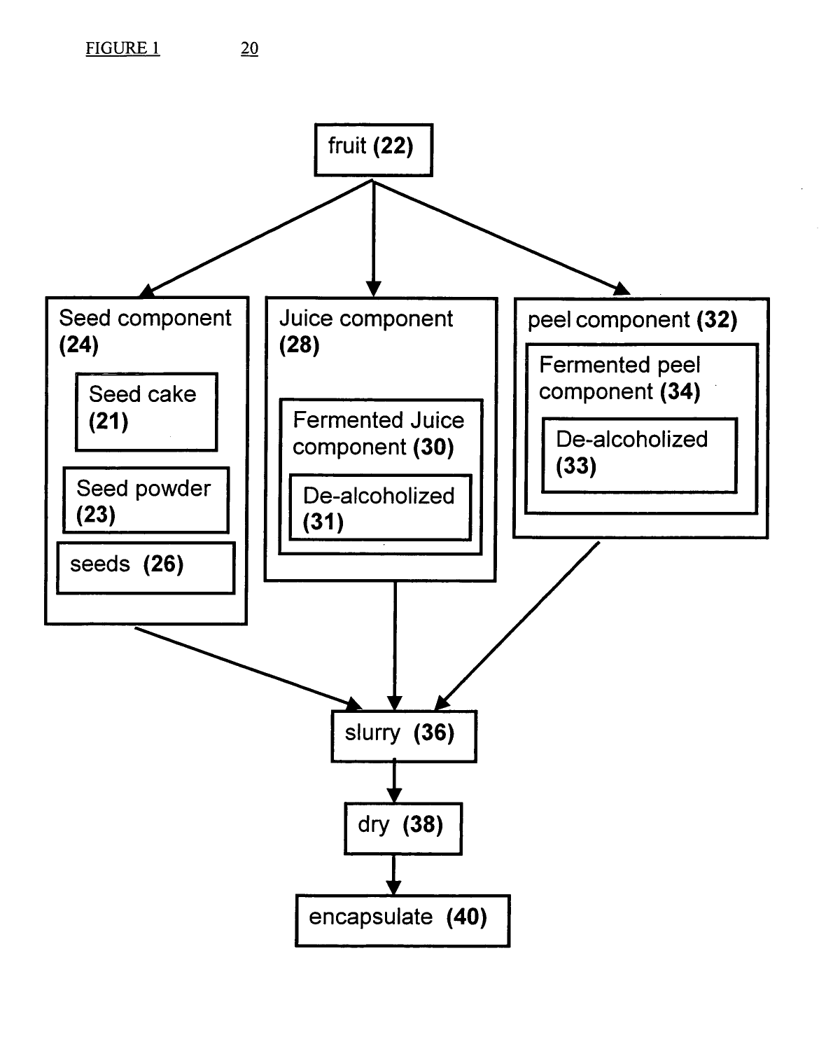

The present invention is preferably embodied by an edible product. The product includes a fruit 22 seed component 24 (FIG. 1) and a dried fruit 22 component 28 or 32, preferably fermented 30 and/or 34. The fruit 22 seed component 24 is impregnated with the dried fruit 22 component 28 or 32, preferably fermented 30 and/or 34. It is stressed that fermentation, although preferred, is not required. The edible product is preferably provided as an article of manufacture further including packaging material and instructions for use. Preferably the edible product is derived at least partially from, more preferably primarily from, most preferably exclusively from, the fruit 22 of the pomegranate (including seeds 24).

Optionally, but preferably, fruit 22 seed component 24 is oil extracted so that the edible product is characterized by a reduced oil content. Most preferably fruit seed component 24 is oil extracted so that it is essentially oil free.

According to still further features in the described preferred embodiments the product is supplied in an orally administrable form selected from the group consisting of a tablet and a capsule.

The invention is further embodied by a method 20 of producing the edible product. Method 20 includes separating fruit 22 into components. Method 20 further includes providing a fruit seed component 24. Method 20 further includes combining the fruit seed component 24 with a liquid 28 or 32 fruit component, preferably fermented 30 and/or 34 to produce a slurry 36. Method 20 further includes drying 38 slurry 36 to produce the edible product including the fruit seed component 24 impregnated with the dried fruit component 28 and/or 32, more preferably 30 and/or 34.

Drying 38 may be accomplished, for example, by spray drying, furnace drying, vacuum drying, freeze drying, paddle drying, agglomerulation or other techniques commonly employed in the food or pharmaceutical industries. Drying 38 at temperatures of 65 degrees C. or higher serves to accomplish de-alcoholization 31 and/or 33 of fermented fruit or peel components 30 and/or 34.

Fruit seed component 24 may include one or more of seed cake 21, seeds 26 and milled seeds (seed powder) 23. Fruit component includes at least one item selected from is the group consisting of a juice 28, a fermented juice 30, a peel extract 32 and a fermentation mixture 34 including primarily fruit peel, water, sugar and yeast. An exemplary method of pomegranate juice fermentation is set forth in U.S. Pat. No. 5,891,440 which is incorporated herein by reference in that regard. Similar reaction conditions may be employed to ferment pomegranate peel.

According to some preferred embodiments of the invention, the edible product includes 5 to 10% w/w, more preferably 7 to 8% w/w, most preferably 7.5% w/w of the dried fruit fermentation component. This formulation is preferably supplied as an article of manufacture with instructions identifying the product as useful in ameliorating symptoms associated with menopause.

According to some preferred embodiments of the invention, the edible product includes 10 to 30% w/w more preferably 14 to 16% w/w, most preferably 15% w/w of the dried fruit fermentation component. This formulation is preferably supplied as an article of manufacture with instructions identifying the product as useful in promoting cardiac health.

Use of the edible product constitutes a method of improving the health of a subject which is an additional preferred embodiment of the invention. The method includes administering a physiologically effective amount of a pomegranate seed component (preferably oil extracted) impregnated with a dried pomegranate fermentation component. According to some preferred embodiments, the method is employed to ameliorate symptoms associated with menopause. According to alternate preferred embodiments the method is employed to promote cardiac health.

In order to maximize the physiologic effect of edible products according to the present invention juice components 28 are preferably prepared from partially fermented or fully fermented juice.

Edible products according to the present invention will preferably be provided as pharmaceutical compositions.

As used herein a “pharmaceutical composition” refers to a preparation of one or more of the active ingredients described herein with other chemical components such as physiologically suitable carriers and excipients. The purpose of a pharmaceutical composition is to facilitate administration of a compound to an organism.

Herein the term “active ingredient” refers to the mixture of pomegranate extracts accountable for the biological or physiologic effect.

Hereinafter, the phrases “physiologically acceptable carrier” and “pharmaceutically acceptable carrier” which may be interchangeably used refer to a carrier or a diluent that does not cause significant irritation to an organism and does not abrogate the biological activity and properties of the administered compound. An adjuvant is included under these phrases.

Herein the term “excipient” refers to an inert substance added to a pharmaceutical composition to further facilitate administration of an active ingredient. Examples, without limitation, of excipients include calcium carbonate, calcium phosphate, various sugars and types of starch, cellulose derivatives, gelatin, vegetable oils and polyethylene glycols.

Techniques for formulation and administration of drugs may be found in “Remington's Pharmaceutical Sciences,” Mack Publishing Co., Easton, Pa., latest edition, which is incorporated herein by reference.

Edible products of the present invention may be manufactured by processes well known in the art, e.g., by means of conventional mixing, dissolving, granulating, dragee-making, levigating, emulsifying, encapsulating, entrapping or lyophilizing processes.

Edible products for use in accordance with the present invention thus may be formulated in conventional manner using one or more physiologically acceptable carriers comprising excipients and auxiliaries, which facilitate processing of the active ingredients into preparations which, can be used pharmaceutically. Proper formulation is dependent upon the route of administration chosen.

For oral administration, the edible product can be formulated readily by combining the active compounds with acceptable carriers well known in the art. Such carriers enable the product to be formulated as tablets, pills, dragees, capsules, liquids, gels, syrups, slurries, suspensions, and the like, for oral ingestion by a patient. Preparations for oral use can be made using a solid excipient, optionally grinding the resulting mixture, and processing the mixture of granules, after adding suitable auxiliaries if desired, to obtain tablets or dragee cores. Suitable excipients are, in particular, fillers such as sugars, including lactose, sucrose, mannitol, or sorbitol; cellulose preparations such as, for example, maize starch, wheat starch, rice starch, potato starch, gelatin, gum tragacanth, methyl cellulose, hydroxypropylmethylcellulose, sodium carbomethylcellulose; and/or physiologically acceptable polymers such as polyvinylpyrrolidone (PVP). If desired, disintegrating agents may be added, such as cross-linked polyvinyl pyrrolidone, agar, or alginic acid or a salt thereof such as sodium alginate.

Dragee cores are provided with suitable coatings. For this purpose, concentrated sugar solutions may be used which may optionally contain gum arabic, talc, polyvinyl pyrrolidone, carbopol gel, polyethylene glycol, titanium dioxide, lacquer solutions and suitable organic solvents or solvent mixtures. Dyestuffs or pigments may be added to the tablets or dragee coatings for identification or to characterize different combinations of active compound doses.

Compositions which can be used orally, include push-fit capsules made of gelatin as well as soft, sealed capsules made of gelatin and a plasticizer, such as glycerol or sorbitol. The push-fit capsules may contain the active ingredients in admixture with filler such as lactose, binders such as starches, lubricants such as talc or magnesium stearate and, optionally, stabilizers. In soft capsules, the active ingredients may be dissolved or suspended in suitable liquids, such as fatty oils, liquid paraffin, or liquid polyethylene glycols. In addition, stabilizers may be added. All formulations for oral administration should be in dosages suitable for the chosen route of administration.

Pharmaceutical compositions suitable for use in context of the present invention include compositions wherein the active ingredients are contained in an amount effective to achieve the intended purpose. More specifically, a therapeutically effective amount means an amount of active ingredients (fruit seed component and fruit fermentation component) effective to prevent, alleviate or ameliorate symptoms of a disorder (e.g., menopause or sub-optimal cardiovascular function) or prolong the survival of the subject being treated.

Determination of a therapeutically effective amount is well within the capability of those skilled in the art, especially in light of the detailed disclosure provided herein.

For any preparation used in the methods of the invention, the therapeutically effective amount or dose can be estimated initially from in vitro and cell culture assays. For example, a dose can be formulated in animal models to achieve a desired concentration or titer. Such information can be used to more accurately determine useful doses in humans.

Toxicity and therapeutic efficacy of the active ingredients described herein can be determined by standard pharmaceutical procedures in vitro, in cell cultures or experimental animals. The data obtained from these in vitro and cell culture assays and animal studies can be used in formulating a range of dosage for use in human. The dosage may vary depending upon the dosage form employed and the route of administration utilized. The exact formulation, route of administration and dosage can be chosen by the individual physician in view of the patient's condition. (See e.g., Fingl, et al., 1975, in “The Pharmacological Basis of Therapeutics”, Ch. 1 p. 1).

Dosage amount and interval may be adjusted individually to provide plasma levels of the active ingredient sufficient to achieve the desired effect (minimal effective concentration, MEC). The MEC will vary for each preparation, but can be estimated from in vitro data. Dosages necessary to achieve the MEC will depend on individual characteristics and route of administration. Detection assays can be used to determine plasma concentrations.

Depending on the severity and responsiveness of the condition to be treated, dosing can be of a single or a plurality of administrations, with course of treatment lasting from several days to several weeks or until cure is effected or diminution of the disease state is achieved. In prophylactic treatment, administration of doses is generally continued over a prolonged period.

The amount of a composition to be administered will, of course, be dependent on the subject being treated, the severity of the affliction, the manner of administration, the judgment of the prescribing physician, etc.

Products according to the present invention may be further incorporated into an article of manufacture including instructions for use.

Products of the present invention may, if desired, be presented in a pack or dispenser device, such as an FDA approved kit, which may contain one or more unit dosage forms containing the active ingredient. The pack may, for example, comprise metal or plastic foil, such as a blister pack. The pack or dispenser device may be accompanied by instructions for administration. The pack or dispenser may also be accommodated by a notice associated with the container in a form prescribed by a governmental agency regulating the manufacture, use or sale of pharmaceuticals, which notice is reflective of approval by the agency of the form of the compositions or human or veterinary administration. Such notice, for example, may be of labeling approved by the U.S. Food and Drug Administration for prescription drugs or of an approved product insert. Compositions comprising a preparation of the invention formulated in a compatible pharmaceutical carrier may also be prepared, placed in an appropriate container, and labeled for treatment of an indicated condition, as if further detailed above.

Products according to the present invention are expected to find utility amelioration of menopausal symptoms and/or promotion of cardiac health.

Products according to the present invention may easily be provided in a variety of forms including, but not limited to, a powder, granules, a tablet, a capsule, a gel-cap, a chewing gum, a food or a candy.

Extracts used in preparing mixtures according to the present invention are preferably prepared from Wonderful cultivar pomegranates. More preferably, these pomegranates are organically grown, still more preferably, they are grown at Kibbutz Sde Eliahu in Israel.

FIG. 1 shows a method 20 of manufacture of an edible product according to the present invention from pomegranate fruit 22. Method 20 preferably combines de-alcoholized (31 or 33) fermented 30 juice component 28 and/or fermented 34 peel product 32 with a seed component 24 (e.g. whole seeds 26, seed cake 21 or milled/powdered seeds 23).

This combining creates a slurry 36 which is dried 38. The resultant seed component 24 impregnated with dried juice component 28 and/or dried. peel component 32 is preferably encapsulated 40 to produce orally ingestible doses of the edible product.

Previous attempts to spray dry pomegranate juice components 28 did not yield a free flowing powder suitable for encapsulation. The present invention therefore relies upon a pomegranate seed component 24 as a solid support. As detailed hereinabove and hereinbelow, a juice component 28 and/or peel component 32 are applied to the solid substrate which remains after slurry 36 is dried 38. As an illustrative example of a method for making an edible product according to the present invention, pressed pomegranate seeds which contained 50% oil from the total amount of the oil normally found in pomegranate seeds 26 were employed. The seeds 26 were sequentially dried, pre-milled to produce coarsely ground seed cake 21 and milled to produce seed powder 23.

Two hundred and fifty kilograms of seeds 26 were dried in a double cone dryer (De Dietrich; Germany, 1M³) at 80 degrees C. and 60-100 mbar for 12 hours. The loss of drying was reduced from 3.5% to 0.5%. The yield approached 100%.

The dried seeds 26 were pre-milled by Retsch rotor beater mill (Germany), SR 300 on 1 mm screen to less than 0.5 mm using partial recycling of the over size fraction (0.5-1 mm). The yield was about 60%. Without recycling the yield was reduced to about 42%.

The pre-milled seeds 21 were milled by Super Fine (Yokneam, Israel) swirl (vortex) mill (model 8) to about D₅₀=25 μm and screened to D₁₀₀=0.2 mm. The yield was about 90% (D₁₀₀<0.2 mm). The total milling (premilling+milling) may be improved by use of partial recycling.

The milled seeds 23 were mixed with the fermented 30 juice component 28 to form slurry 36. Juice component 28 was approximately 22% solids on drying [bench scale] or 15% solids on drying with 5-10% ethanol [scale up]. Slurry 36 was dried to produce an edible product (powder) with milled seeds 23 impregnated with fermented 30 juice component 28 in a ratio of 15-30% w/w. Drying 38 was accomplished by spray drying using either a Niro (Copenhagen, Denmark) Mobile Minor dryer [bench scale] or a Niro Production Minor [scale up] operating in the range of 350 degrees C.-110 degrees C. (temperatures of inlet and outlet air respectively). The drying capacities of water evaporation were 4 kg/hr water and 22 kg/hr respectively. Residual alcohol was effectively removed by drying 38.

The solids concentrations in the suspension (milled seeds and dry fermented juice) were 5% and 13% respectively. Using these methods, impregnation of 15-25% dried fermented 30 juice 28 in the edible product. Milled seeds containing 100% oil (premilling of whole seeds) or 0% oil (pressed and extracted seeds) may be employed without significantly altering the outcome of the process.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

1. An edible product, the product comprising:
(a) a fruit seed component; and
(b) a dried fruit component;
wherein said fruit seed component is impregnated with said dried fruit component.

2. The product of claim 1, wherein said fruit seed component includes at least one item selected from the group consisting of a seed cake, seeds, milled seeds and seed powder.

3. The product of claim 1, wherein said fruit component includes at least one item selected from the group consisting of a juice, a fermented juice, an extract of peel and a fermentation mixture which includes primarily fruit peel, water, sugar and yeast.

4. The product of claim 1, comprising 5 to 10% w/w of said dried fruit fermentation component.

5. The product of claim 1, comprising 10 to 30% w/w of said dried fruit fermentation component.

6. The product of claim 1, wherein said fruit is a pomegranate.

7. The product of claim 1, wherein said fruit seed is oil extracted.

8. An article of manufacture, the article of manufacture comprising the product of claim 1, packaging material and instructions for use.

9. The article of manufacture of claim 8, wherein said instructions identify said product as useful in ameliorating symptoms associated with menopause.

10. The article of manufacture of claim 8, wherein said instructions identify said product as useful in promoting cardiac health.

11. The article of manufacture of claim 8, wherein said product is supplied in an orally administrable form selected from the group consisting of consisting of a tablet and a capsule.

12. A method of producing an edible product, the method comprising:
(a) providing a fruit seed component;
(b) combining said fruit seed component with a liquid fruit component to produce a slurry; and
(c) drying said slurry to produce the edible product comprising said fruit seed component impregnated with a dried fruit component.

13. The method of claim 12, wherein said fruit seed component includes at least one item selected from the group consisting of a seed cake, seeds, milled seeds and seed powder.

14. The method of claim 12, wherein said liquid fruit component includes at least one item selected from the group consisting of a juice, a fermented juice, an extract of peel and a fermentation mixture which includes primarily fruit peel, water, sugar and yeast.

15. The method of claim 12, wherein said dried fruit component comprises 5 to 10% w/w of the edible product.

16. The method of claim 12, wherein said dried fruit fermentation component comprises 10 to 30% w/w of the edible product.

17. The method of claim 12, wherein said fruit is a pomegranate.

18. The method of claim 12, wherein said fruit seed is oil extracted.

19. A method of improving the health of a subject, the method comprising administering a physiologically effective amount of a pomegranate seed component impregnated with a dried pomegranate fermentation component.

20. The method of claim 19, employed to ameliorate symptoms associated with menopause.

21. The method of claim 19, employed to promote cardiac health.
